(19) United States
(12) Patent Application Publication
(10) Pub. No.: US 2026/0219083 A1
(43) Pub. Date: Jul. 30, 2026

(54) REPULSIVE ELECTRICAL SOFTENING FOR CAPACITIVE SENSORS AND ACTUATORS

(71) Applicant: The Research Foundation for the State University of New York, Albany, NY (US)

(72) Inventors: Johar Pourghader, Binghamton, NY (US); Ronald Miles, Binghamton, NY (US); Weili Cui, Vestal, NY (US)

(21) Appl. No.: 19/465,647

(22) Filed: Jan. 30, 2026

Related U.S. Application Data
(60) Provisional application No. 63/751,591, filed on Jan. 30, 2025.

(51) Int. Cl. G01F 1/58; H02N 11/00

(52) U.S. Cl. CPC G01F 1/584; H02N 11/006

(57) ABSTRACT

A system and method for softening capacitive sensors and actuators in MEMS by using repulsive electrodes adjacent a sensing movable component. The sensor has a substrate with an insulating layer thereupon and a fluid flow passage, such as a cavity, is formed in at least the insulating layer and can extend through the substrate. The cavity is configured to allow a fluid flow therethrough, such as air. A first electrode and second electrode are formed on the insulating layer adjacent the fluid flow passage, and a movable component is held over the fluid flow passage and changes a capacitance based upon a detected fluid flow. Repulsive forces from the first and second electrodes limit noise from other electrical forces and externally by stabilizing the movable component.

### CROSS-REFERENCE TO RELATED APPLICATION

This application claims the benefit of U.S. Provisional Patent Application No. 63/751,591, filed Jan. 30, 2025, the entirety of which is hereby incorporated herein by this reference.

### STATEMENT REGARDING FEDERALLY SPONSORED RESEARCH

This invention was made with government support under grant number DC017720, awarded by the National Institutes of Health. The government has certain rights in the invention.

### BACKGROUND

The present invention generally relates to microelectromechanical systems (MEMS) and methods of their fabrication. More particularly, the present invention relates to a system and method for softening capacitive sensors and actuators in MEMS by using repulsive electrodes adjacent to a sensing movable component.

Several types of known electrostatic sensors utilize two different types of electrostatic electrodes in a MEMS sensor with one electrode resulting in attractive electrostatic forces that pull the biasing electrode and the moving electrode together and at least one additional electrode that applies a force in the opposite direction to the moving electrode. This second electrode will be referred to as a “repulsive” electrode.

Existing sensors require a bias voltage to be applied to an electrostatic electrode, creating an electric field between the fixed electrode and the moving electrode. A prior art electrostatic sensor 10 is shown in FIG. 1. A bulk silicon substrate 12 has a layer of SiO₂, upon which is formed a middle plate 16 and two conductive side electrodes 18. There is a movable plate 20 that is used to detect physical particle motion, such as sound.

Unfortunately, the electrostatic field also generates a force that affects the dynamics of the moving plate 20. Previous technologies utilizing a repulsive force for electrostatic actuation or sensing typically required multiple layers of conducting material, such as SiO₂ layer 14 and a conductive layer to form the middle plate 16 and side electrodes 18 to be deposited on a bulk silicon wafer 12 which were separated by a sacrificial, insulating layer such as the SiO₂ layer 14. This is due to the repulsive side electrodes 18 needed to be in a separate layer from the movable plate 20. These added layers are often costly and complex to fabricate.

In the prior art electrostatic sensor 10, the side electrodes 18, also called repulsive electrodes, are connected to a voltage source to create a levitation force against the movable plate 20. The movable plate 20 is virtually grounded.

### BRIEF SUMMARY

Briefly described, the present system and method employs a single-layer device structure, which can be patterned using photolithography in which the existence of the grounded bulk silicon itself blocks the unwanted electric fields that would decrease the upward repulsive force. The ability to create both attractive and repulsive electrodes on a single added conductive layer significantly reduces complexity and cost, making it a more efficient and economical solution for MEMS sensor design.

This invention provides a practical way to eliminate this electric force and prevent the applied electric field from affecting the motion of the moving element. This innovation enables the design and fabrication of silicon sensors using conventional planar lithography in standard silicon microfabrication processes. It allows for sensor designs with higher signal levels and minimizes electronic noise.

The invention further provides a repulsive force that can be utilized within a single layer of silicon to enhance the amplitude of the response and therefore Signal to Noise Ratio (SNR) (i.e., increase the movement of the movable electrode) and induce softening by reducing the natural frequency of the movable beam. This enables the design of two sets of electrodes: one intended to decrease the natural frequency (softening or repulsive electrode) and the other to increase the natural frequency (hardening electrode). By increasing the voltage on both the softening and hardening electrodes, the output response can be amplified significantly, allowing for the inclusion of substantial electrical energy in the system without experiencing pull-in phenomena. Thus, a grounded bulk silicon allows for the placement of a repulsive electrode within one layer of crystal silicon.

In one embodiment, the invention includes a sensor having a substrate, with an insulating layer on the substrate. A fluid flow passage is formed in the insulating layer and is configured to allow a fluid flow therethrough. There is a first electrode and a second electrode formed on the insulating layer adjacent the fluid flow passage, and a movable component is held over the fluid flow passage that changes a capacitance based upon a detected fluid flow. The fluid flow passage can be a cavity configured to detect a fluid flow within the cavity indicating sound. The movable component can be an elastically deformable beam that changes capacitance with deformation or a movable component is a movable plate held within the cavity.

In an embodiment, the insulating layer has a top surface plane and the first electrode, second electrode, and movable component are in a same plane as the top surface plane of the insulating layer. And the cavity can be further formed within or through the substrate. The substrate can be comprised of bulk silicon and the insulating layer can be SiO₂. The sensor can also include a sensing electrode adjacent to the movable component.

In an embodiment, the invention includes an actuator including a substrate, an insulating layer on the substrate, a first repulsive electrode formed on the insulating layer, a second repulsive electrode formed on the insulating layer, a first fixed electrode adjacent the first repulsive electrode, a second fixed electrode adjacent the second repulsive electrode, and a movable component held within the cavity between the first fixed electrode and second fixed electrode, the movable component configured to change a capacitance based upon a predetermined condition. The actuator can further include a cavity formed in the insulating layer and substrate, the cavity formed between the first repulsive electrode and second repulsive electrode.

In another embodiment, the invention includes a method of fabricating a sensor by placing an insulating layer on a substrate, creating a first set of features on the insulating layer, the first set of features including a first electrode, a second electrode, and a movable component. The movable component is configured to change a capacitance based upon a detected fluid flow. The method continues with forming a fluid flow passage in the insulating layer around, at least, the movable component, and the fluid flow passage is configured to allow a fluid flow therethrough. The method can include forming a sensing electrode on the insulating layer adjacent to the movable component.

The step of creating a first electrode and second electrode can be forming a first repulsive electrode and a second repulsive electrode, and the method will then include forming a first fixed electrode and second fixed electrode adjacent the movable component and the fluid flow passage is a cavity further formed around the movable component, the first fixed electrode, and second fixed electrode. Forming the movable component can be forming an elastically deformable beam that changes capacitance with deformation. And the method can include placing the substrate on an electronic circuit.

The invention presented herein addresses a broad spectrum of technological applications and industries. This invention disclosure encompasses MEMS microphones and sensors tailored for consumer electronics. It extends to the domains of micro-robots, artificial intelligence, Internet of Things (IoT), Augmented Reality (AR), Virtual Reality (VR), Biomedical Devices, and Robotics and Automation. The invention thus provides an advantage in creating a more accurate MEMS sensor.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is a diagram of a prior art MEMS sensor with a movable plate interacting with a patent of side electrodes.

FIG. 2A is a diagram of one embodiment of a single layer sensor

FIG. 2B is a diagram of a further embodiment of a one-layer design sensor in FIG. 2A, with backside etching of the bulk Si substrate.

FIG. 3 is a perspective view of the embodiment of the sensor design in FIG. 2B.

FIG. 4 is an image of the electric fields for a prior art sensor.

FIG. 5 is an image of the electric fields for the sensor of FIG. 2B.

FIG. 6 is a cross section on one embodiment of a MEMS sensor using the present inventive design.

FIG. 7 is a top view of the MEMS sensor of FIG. 6.

FIG. 8 one embodiment of actuator, embodied with only one moving finger and two fixed fingers for clarity.

FIG. 9 is a illustrates the electrostatic field surrounding the structure of FIG. 8, as modeled using COMSOL, a Finite Element Analysis (FEA) software.

FIG. 10 is a schematic diagram on one embodiment of MEMS senor array of all the electrodes in one layer including the fixed electrode, movable electrode, and repulsive electrode.

FIG. 11 is a simplified diagram of the MEMS array in FIG. 10.

FIG. 12A is a graph of the effect of biased voltage on the lateral electrode on the natural frequency and response of an actuator illustrating Amplitude of a Velocity(mm/s)/Vac.

FIG. 12B is a graph of the effect of biased voltage on the lateral electrode on the natural frequency and response of the MEM actuator, illustrating its phase.

FIG. 13 is a graph of the effect of bias voltage on lateral electrodes on the thermal noise in a plumose design.

FIG. 14A is a graph illustrating the effect of biased voltage on the lateral electrode on the sensitivity of MEMS microphone with the amplitude of sensitivity (Volts/Pa) shown.

FIG. 14B is a graph illustrating the effect of biased voltage on the lateral electrode on the sensitivity of MEMS microphone with the phase shown.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

As an initial matter, in order to clearly describe the current disclosure it will become necessary to select certain terminology when referring to and describing relevant components within the disclosure. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

With reference to the figures in which like numerals represent like elements throughout the several views, FIG. 2A is one embodiment of the one-layer design for a MEMS sensor 30, which is the current state of the art in fabrication. There is a sensor 30 having a substrate 32, shown here as a bulk silicon substrate, with an insulating layer 34 disposed on and/or formed over at least a portion of the substrate 32. A fluid flow passage 36 is formed in and/or through, at least a portion, of the insulating layer 34 and is configured to allow a fluid flow therethrough. In exemplary embodiments, fluid flow includes, but is not limited to, an air or liquid flow that can contain sound waves. In this embodiment, the fluid flow passage 43 is a cavity or opening formed in and/or through the insulating layer 34. Additionally as shown in FIG. 2A, sensor 30 also includes a first electrode 38 and a second electrode 40 formed on the insulating layer 34, respectively, adjacent the fluid flow passage 36. Sensor 30 further includes a movable component 42 held, positioned, formed, and/or disposed within and/or adjacent the fluid flow passage 36. In non-limiting embodiments, movable component 42 is configured to change a capacitance based upon a detected fluid flow within the fluid flow passage 36, such as a traveling sound wave. The fluid flow passage 36 and/or movable component 42 can be specifically configured to allow for the detection of a fluid flow within the fluid flow passage 36 indicating sound. The movable component 42 can be an elastically deformable beam that changes capacitance with deformation and/or can be a movable plate held within the fluid flow passage 36, as shown.

In an embodiment, the insulating layer 34 has a top surface plane 44 and the first electrode 38, second electrode 40, and movable component 42 are in the same plane as the top surface plane 44 of the insulating layer 34. That is, first electrode 38 and second electrode 40 are aligned and/or formed in the same plane (e.g., top surface plane 44 of insulating layer 34), while movable component 42 is configured to be positioned within the same plane as first electrode 38 and second electrode 40 during operation of sensor 30. The fluid flow passage 36 can be further formed within and/or through at least a portion of the substrate 32. The substrate 32 can be comprised of bulk silicon and the insulating layer 34 can be SiO₂. The sensor 30 can also include a sensing electrode adjacent to the movable component.

FIG. 2B is a diagram of a further embodiment of a one-layer design sensor 50 with backside etching of the bulk Si substrate creating a fluid flow passage 56 through the substrate 52. The MEMS sensor 50 has a substrate 52, shown here as a bulk silicon substrate, with an insulating layer 54 formed on and/or disposed over the substrate 52. A fluid flow passage 56 is formed through the insulating layer 54 and/or is formed between substrate 52 and insulating layer 54, respectively. Fluid flow passage 56 is configured to allow a fluid to flow therethrough, where the fluid includes, but is not limited to, air or liquid flow that can contain sound waves. Sensor 50 also includes a side electrode 58 and a distinct, side electrode 60 formed on the insulating layer 54 adjacent to and/or on opposing sides of the fluid flow passage 56. As shown in FIG. 2B, sensor 50 further includes a movable component 62 held within and/or formed adjacent to the fluid flow passage 56 that, in this embodiment, changes a capacitance based upon a detected fluid flow within the fluid flow passage 36, such as a traveling sound wave. The movable component 62 can be an elastically deformable beam that changes capacitance with deformation and/or can be a movable plate held within the fluid flow passage 56, as shown.

Here, the insulating layer 54 has a top surface plane 64 and the side electrode 58, side electrode 60, and movable component 62 are in the same plane as the top surface plane 64 of the insulating layer 54. That is, side electrode 58 and distinct side electrode 60 are aligned and/or formed in the same plane (e.g., top surface plane 64 of insulating layer 54), while movable component 62 is configured to be positioned within the same plane as side electrode 58 and electrode 60 during operation of sensor 50. Additionally as shown in the non-limiting example, the fluid flow passage 56 can be further formed within and/or through the substrate 52 as is shown in FIG. 2B. The substrate 52 can be comprised of bulk silicon and the insulating layer 34 can be SiO₂.

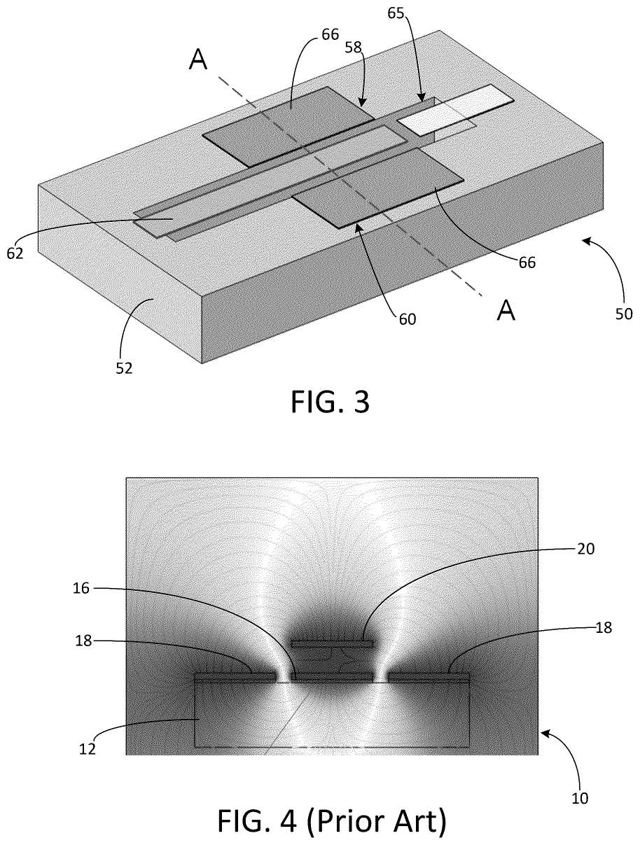

FIG. 3 is a perspective view of the embodiment of the sensor design in FIG. 2B, which is the cross-sectional view along Line A-A in FIG. 3. The sensor 50 is formed on a bulk substrate 52 with a cavity 65 (containing the fluid flow passage) formed in the substrate 52. The insulating layer 54 is not illustrated in FIG. 3. The movable component (movable electrode 62) is positioned over the cavity 65, and the movable component is embodied here as a cantilever beam that is fixed on one end and is free on the other sides. There can be a sensing electrode adjacent to the movable electrode 62. Side electrodes 58, 60, formed as repulsive electrodes 66, are also formed adjacent to the cavity 65 and/or formed parallel to and substantially planar with the movable electrode 62.

The embodiment of the sensor 50 in FIGS. 2B and 3 promotes a softening effect to eliminate the adverse hardening effects of bias voltage (e.g., increased signal level and decreased electrical noise) on the movable electrode 62. The non-limiting example, sensor 50 is easier to fabricate, does not exert force to “pull-in” the movable electrode 62, and has a significant range of freedom of the movable electrode 62 for ultrasensitive sound detection. Moreover, the present design is applicable for different types of sensors and actuators, not just those for sound detection.

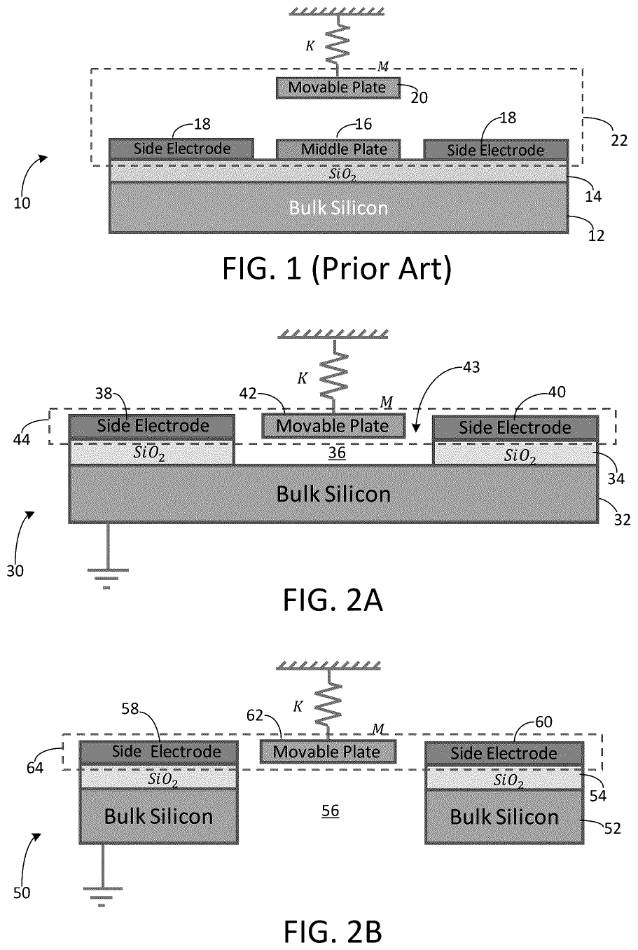

FIG. 4 is an image of the electric fields for a prior art sensor 10 of FIG. 1. As illustrated, the prior art sensor 10 needs extra electrodes (middle plate 16) and therefore requires multi-level silicon microfabrication, such as in a dual plane 22 (see, FIG. 1), which includes movable plate 20 in a different plane than the middle plate 16.

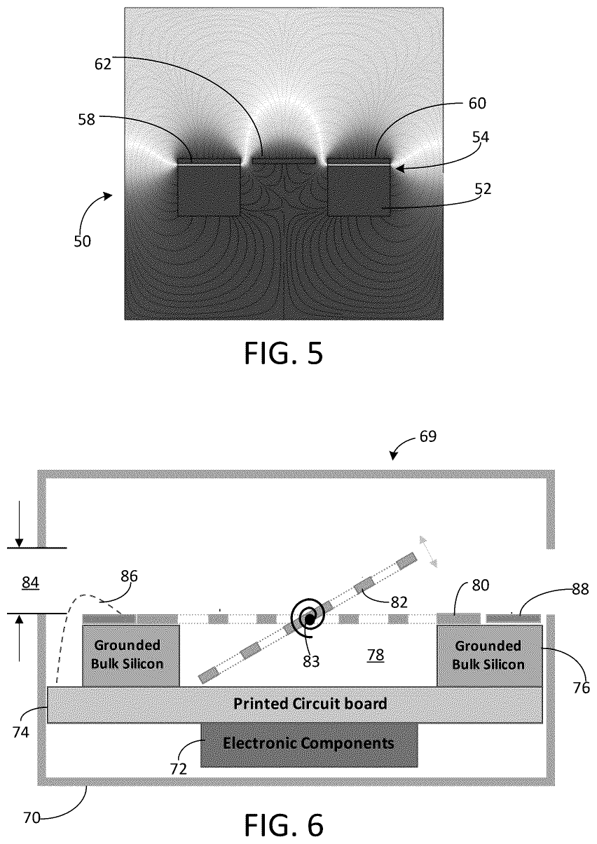

FIG. 5 is an image of the electric fields for the sensor 50 of FIGS. 2B and 3. The image shows the bulk silicon substrate 52 at zero voltage (grounded) shields the electrostatic fields and protects the movable electrode 62 from the downward electrical force, eliminating the need for an additional electrode to perform this function. This unbalanced electric force (e.g., only from upward) can levitate the movable electrode 62 and make it more sensitive to small stimuli.

FIG. 6 is a cross section on one embodiment of a MEMS sensor 69 using the present inventive design. FIG. 6 illustrates a small rotation (due to vibration) of the movable electrode lever 82 around its hinge 83 to illustrate the vibration (e.g., rotation) of the movable electrode lever 82 around the hinge(s) 83. In a housing 70 having an acoustic port 84 to let in sound, the device is layered on electronic components 72 and a printed circuit board 74. Grounded bulk silicon 76 is directedly placed in and/or formed directly on the printed circuit board 74 creating and/or defining a cavity 78 for a moving electrode lever 82. There are fixed electrodes 80 and a repulsive electrode 88 formed adjacent to the cavity 78. Here, a wire 86 provides a bias voltage to each repulsive electrode 88. In this configuration, the moving electrode lever 82 will move about hinge 83 with sound traveling through the cavity 78.

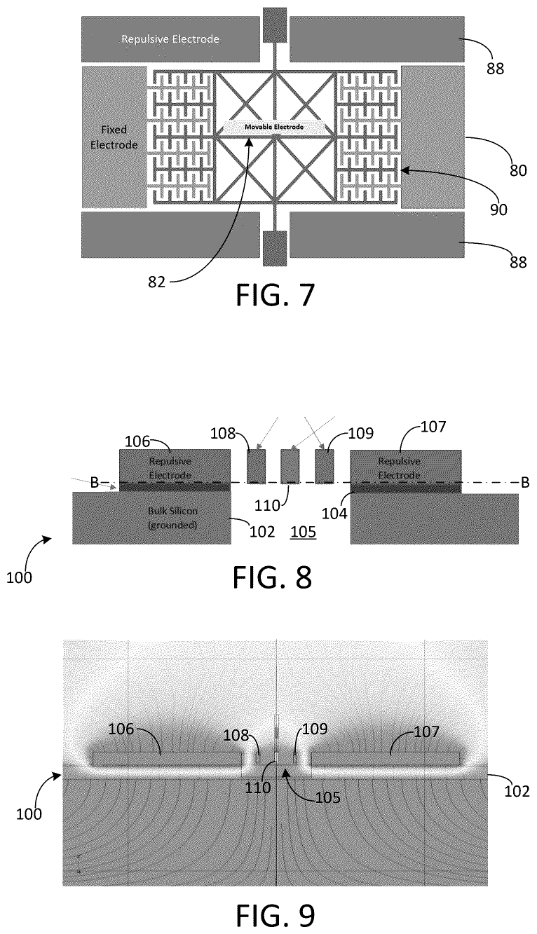

FIG. 7 is a top view of the MEMS sensor 69 of FIG. 6 illustrating the relationship of the moving electrode 82 teetering between the fixed electrodes 80 to indicate the presence of sound. The interdigitated fingers 90 of moving and fixed electrodes are also clearly visible.

It should be appreciated that when this repulsive configuration is used as a microphone, sound (acoustic particles) can flow into the cavity 78 (see, FIG. 6). However, if it is used as another type of sensor or actuator, airflow is not necessarily required.

FIG. 8 is an embodiment of an actuator 100, embodied with only one moving finger (e.g., moving electrode 110) and two fixed fingers (e.g., fixed electrodes 108,109) for clarity. In the non-limiting example, the fixed electrodes 108,109, moving electrode 110, and repulsive electrodes 106,107 are all integrated, formed, and/or aligned within a single layer (e.g., in plane B), to generate an upward repulsive force on the moving electrode 110. This force acts to lift the moving electrode 110 during operation. The attractive electric force between the fixed electrodes 108,109 and moving electrode 110 acts to keep the moving electrode 110 in an initial position, while the repulsive force works to counteract the attractive electric force, pulling the moving electrode 110 away from the initial position. This simplified structure featuring one moving finger (e.g., beam of moving electrode 110) and two fixed beams (e.g., fixed electrodes 108,109) positioned on top of an SiO₂ or insulative layer 104 and bulk silicon substrate 102, with a cavity 105 formed underneath and/or adjacent the fixed electrodes 108,109 and moving electrode 110, respectively.

In the embodiment of FIG. 8, the actuator 100 includes an Si substrate 102 with an insulating layer 104 formed over and/or on the substrate 102, a first repulsive electrode 106 and a second repulsive electrode 107 formed on the insulating layer 104, respectively.

In this embodiment, cavity 105 is formed in the insulating layer 104 and substrate 102, and cavity 105 is formed between the first repulsive electrode 106 and second repulsive electrode 107, respectively. The cavity 105 can be configured to allow a fluid flow therethrough. When this repulsive configuration is used as a microphone, sound (e.g., acoustic particles) can flow into the cavity 105, however, if it is used as another type of sensor or actuator, airflow is not required and some other predetermined condition can cause detection of the actuator, such as a change in temperature, motion, and/or electromagnetic field.

In the exemplary embodiment, first fixed electrode 108 is held, positioned, and/or disposed within the cavity 105, and a second fixed electrode 109 held, positioned, and/or disposed within the cavity 105, adjacent to first fixed electrode 108. Movable electrode 110 is also held, positioned, and/or disposed within the cavity 105, between the first fixed electrode 108 and second fixed electrode 109. During operation, the movable electrode 110 is configured to change a capacitance. This change in capacitance, due to the flow-induced motion of the electrode, can be used to indicate the fluid flow within the cavity 105.

FIG. 9 is a illustrates the electrostatic field surrounding the actuator 100 structure, as modeled using COMSOL, a Finite Element Analysis (FEA) software. FIG. 9 shows the electric potential (V) lines around the actuator 100 when the voltage on the fixed electrodes 108,109 is 10 Volts and the voltage on the repulsive electrodes 106,107 is 400 Volts. The substrate 102 blocks the electric field lines underneath the moving electrode 110. This results in an upward net force on the moving electrode 110 due to the influence of the repulsive electrodes'106,107 upper side which pulls up the moving electrode 110, resulting in decrease in the natural frequency. For small motions of the moving electrode 110, both the attractive and repulsive electrodes 106,107 result in electrostatic forces that vary linearly with its deflection. As a result, these forces act like those of electrostatic springs where the attractive fixed electrode 108,109 acts like a conventional linear spring with positive stiffness while the repulsive electrode 106,107 acts like springs having negative stiffness. The combination of these two effective springs, having opposite signs, results in cancellation of the force and the stiffness. The repulsive force acts to effectively negate the stiffness introduced by the conventional attractive electrode.

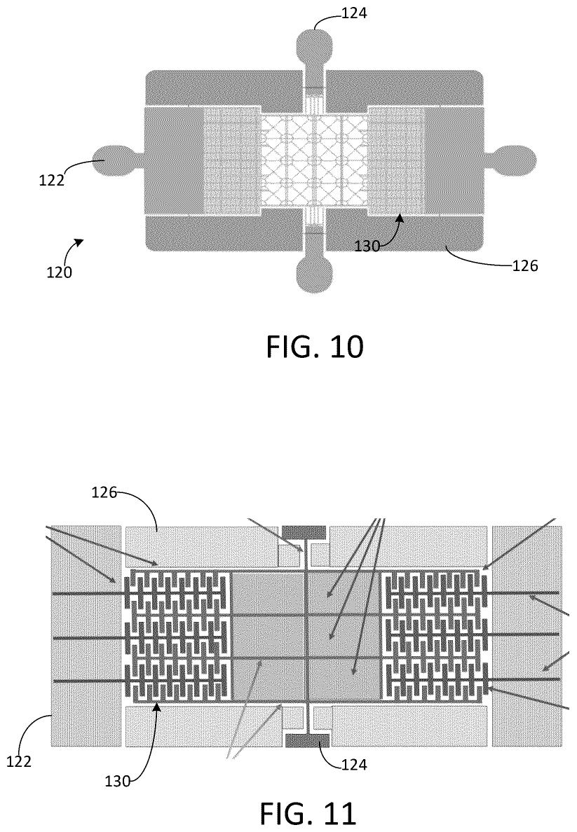

FIG. 10 is a schematic diagram on one embodiment of MEMS sensor 120 of all the electrodes in one layer including the fixed electrode 108,109, movable electrode 110, and repulsive electrode 106,107 (see, e.g., FIG. 8). FIG. 10 shows the fixed electrodes 122, the movable electrode 124, and the repulsive electrodes 126. The stiffening force arises from the electrostatic interaction between the repulsive electrodes 126 and fixed electrodes 122, where the interdigitated fingers generate an attractive force that endeavors to keep the movable electrode 124 in its resting position. Simultaneously, the repulsive electrodes 126, deposited and located above the existing bulk silicon or substrate, contribute to an upward force that counteracts the attractive force from the fixed electrodes 122. Additionally, a simplified version of FIG. 10 is shown in a close-up of array 130 in FIG. 11. FIG. 11 is a simplified diagram of the MEMS sensor 120 in FIG. 10.

The electrodes in this embodiment are created using photolithography techniques with a 5 μm device layer on a SOI (Silicon-On-Insulator) wafer, positioned above a 500 μm bulk silicon substrate, separated by a 1 μm SiO2 layer. The moving electrode 110 is linked to a compliant hinge support, while both the moving electrode 106,107 and fixed electrodes 108,109 feature fingers, maintaining a 6 μm gap between them to facilitate capacitive sensing. The moving electrode 110 is virtually grounded by the read-out circuit. Fixed electrodes 108,109 are biased with 6 volts DC. When a test sound occurs by fluid flow in the cavity 105, the movable electrode 110 moves. Increasing the movable electrode's 110 displacement amplitude increases the output signal from the microphone. However, the difference in voltage between fixed electrodes 108,109 and moving electrode 110 creates an attractive force between them that pulls the movable electrode 110 towards fixed electrodes 108,109. Because this force depends on the gap between the electrodes, it creates a displacement-dependent stiffness which decreases the output signal and, consequently, decreases the dynamic range of the microphone. Applying a bias voltage to the repulsive electrodes 106,107 creates a net upward force, which pulls up the moving electrode 110. This action softens the moving electrode 110 and enhances its movement, resulting in an increased signal received from the actuator 100.

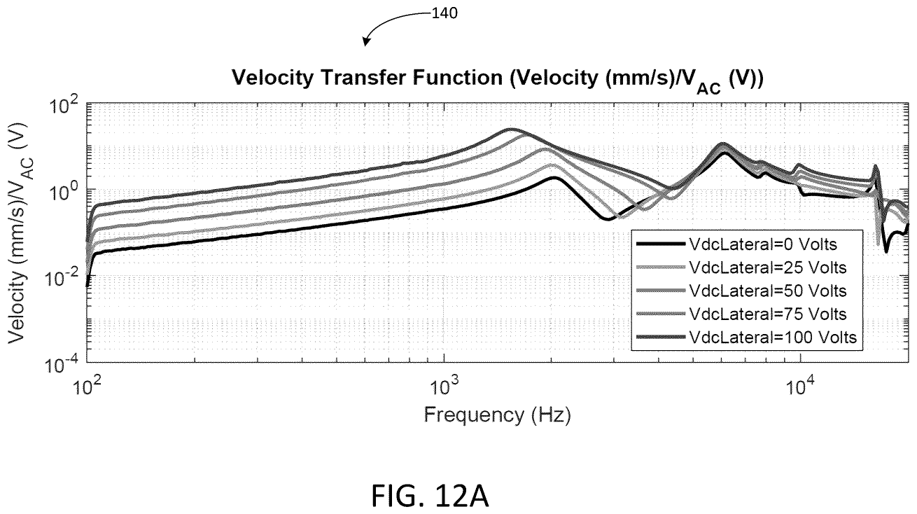

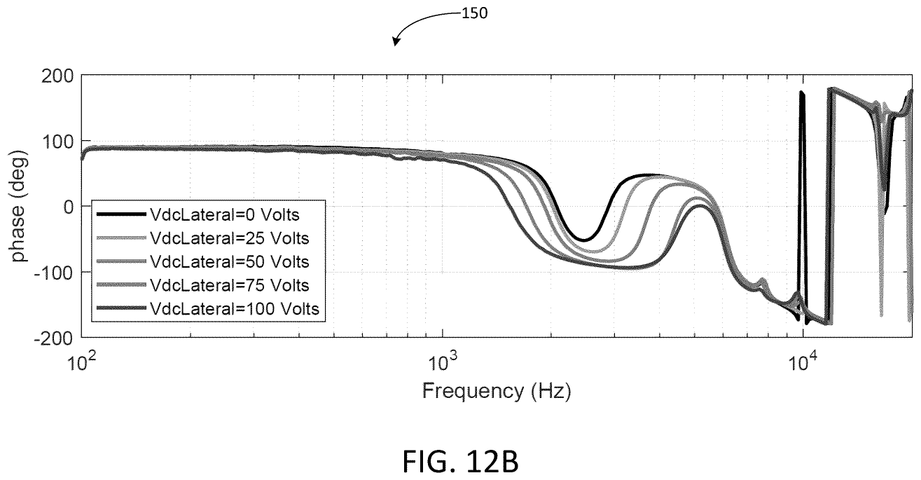

FIG. 12A is a graph 140 of the effect of biased voltage on the lateral electrode on the natural frequency and response of an actuator 100 detecting an AC voltage. Graph 140 illustrates Amplitude of a Velocity(mm/s)/Vac. FIG. 12B is a graph 150 of the effect of biased voltage on the lateral electrode on the natural frequency and response of the MEMS actuator, illustrating its phase. When the bias voltage on the lateral repulsive electrodes 106,107 is set to zero and the voltage on the fixed electrodes 108,109 is 6 volts DC superimposed by 1 volt AC, the natural frequency is measured at 2070 Hz, and the Velocity/Voltage-AC ratio is calculated as 1.8 mm/s/volt.

Increasing the bias voltage on the lateral repulsive electrodes 106,107 up to 100 volts results in a decrease in the natural frequency to 1530 Hz, with the Velocity/Voltage-AC ratio reaching 24 mm/s/volt. This signifies a decrease in the natural frequency by 35%, while the response in desired displacement is amplified by more than 1200%. This data is depicted in FIG. 12A and FIG. 12B.

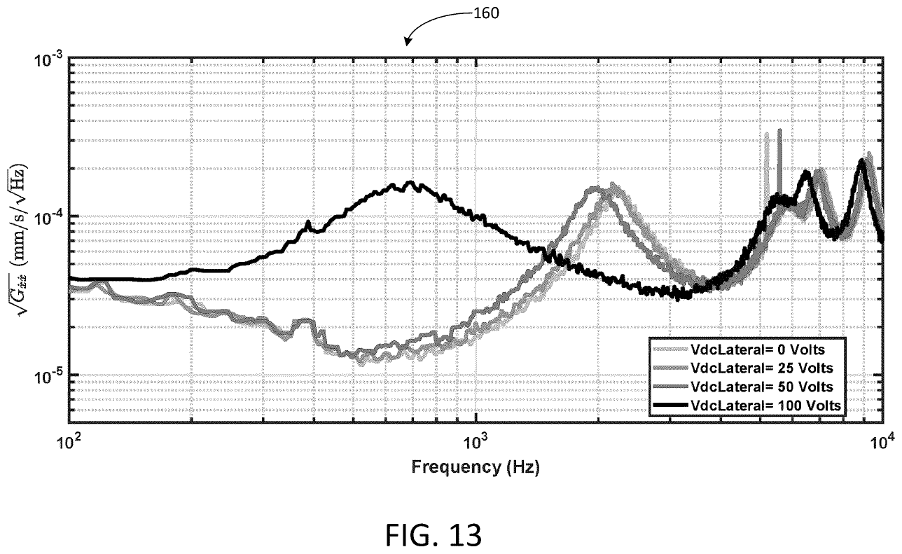

FIG. 13 is a graph 160 of the effect of bias voltage on lateral repulsive electrodes 106,107 on the response due to thermal noise. Thermal noise arises from the inherent random movement of air molecules colliding with the moving electrode 110. This stochastic force compels the moving electrode 110 to displace by approximately 1 nanometer in laboratory conditions and is intricately linked to temperature variations. Notably, FIG. 13 illustrates that while increasing the biased voltage decreases the first natural frequency of the structure, the level of thermal noise remains consistent.

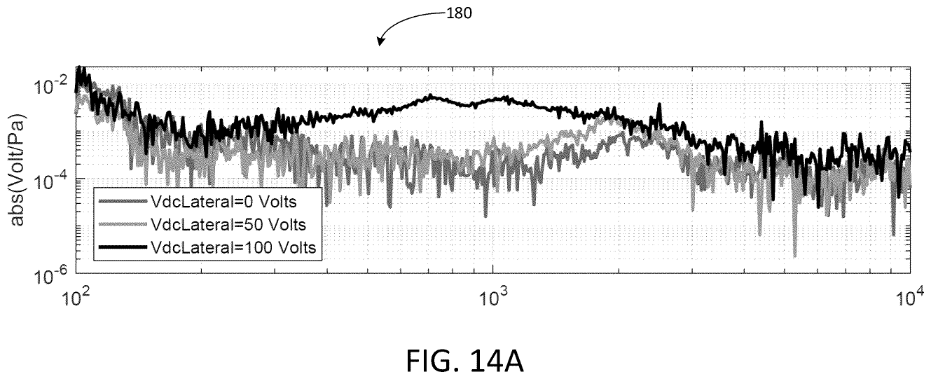

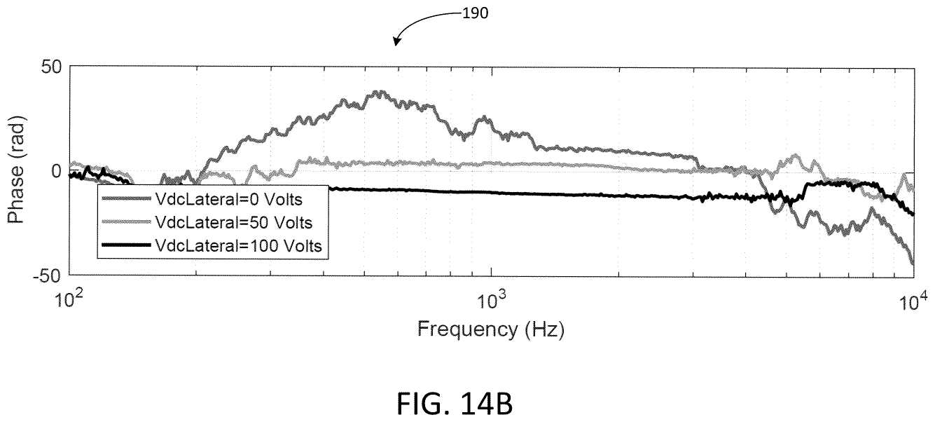

FIG. 14A is a graph 180 illustrating the effect of biased voltage on the lateral electrode on the sensitivity of MEMS microphone with the amplitude of sensitivity (Volts/Pa) shown. FIG. 14B is a graph 190 illustrating the effect of biased voltage on the lateral electrode on the sensitivity of MEMS microphone with the phase shown. The sensitivity of a sensor stands as a crucial parameter in sensor design, representing its performance. In the case of microphones, sensitivity signifies the ratio of the generated voltage by the microphone divided by the sound pressure. Lower sensitivity leads to greater dominance of noise, resulting in lower quality data.

Conversely, sensors with higher sensitivity typically yield higher-quality signals. It is also highly desirable that the sensitivity not vary with the frequency of the sound. This will ensure that sounds can be detected with good fidelity. A notable observation was made when increasing the bias voltage of lateral electrodes shown in FIGS. 14A and 14B. The sensitivity rose significantly from 0.00063 volts/Pascal to 0.0049 volts/Pascal, marking an increase of over 600%. The addition of the repulsive electrode 106,107 enabled the use of a higher bias voltage resulting in dramatically higher performance.

Thus, and with reference again to FIGS. 2A, 2B and FIG. 8, a method of fabricating a sensor 30 includes placing an insulating layer 34 on a substrate 32, creating a first set of features on the insulating layer 34, the first set of features including a first electrode 38, a second electrode 40, and a movable component (e.g., movable plate 42). The method also includes forming a fluid flow passage 36 (e.g., cavity) in the insulating layer 34 around, at least, the movable component (e.g., movable plate 42), and the cavity is configured to allow a fluid flow therethrough. The movable component is configured to change capacitance enabling electronic sensing of the fluid flow within the cavity. The method also includes forming a sensing electrode on the insulating layer 34 adjacent to the movable component (movable plate 42).

The step of creating a first electrode 38 and second electrode 40 (FIG. 2A) can be forming a first repulsive electrode 106 (FIG. 8) and a second repulsive electrode 107. In exemplary embodiments, the method also includes forming a first fixed electrode 108 and second fixed electrode 109 adjacent the movable component (movable electrode 110; FIG. 8) and the cavity 105 is then further formed around the movable component (movable electrode 110), the first fixed electrode 108, and second fixed electrode 109, respectively. Forming the movable component can include forming an elastically deformable beam that changes capacitance with deformation. And the method can include placing the substrate 76 on an electronic circuit (printed circuit board 74; see, FIG. 6).

Although discussed herein as receiving, detecting, and/or engaging a fluid flow therein, other exemplary embodiments of the structures discussed herein are configured to detect additional operational characteristics and/or form distinct components. For example, the various structure discussed herein can operate and/or function without the need of fluid flow, and can be formed, for example, as resonators, gyroscopes, or other inertial and/or sensing components. In the exemplary embodiments, deformation of the movable electrode can be created due to, for example, inertia, acceleration, and/or change of electric field and so on.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” and/or “substantially” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A sensor, comprising:
a grounded substrate;
an insulating layer on the substrate;
a fluid flow passage on the substrate;
a first electrode formed on the insulating layer adjacent the fluid flow passage;
a second electrode formed on the insulating layer adjacent the fluid flow passage; and
a movable component over the fluid flow passage, the movable component configured to change a capacitance based upon a detected fluid flow within the fluid flow passage.

2. The sensor of claim 1, wherein the fluid flow passage is a cavity further configured to detect a fluid flow within the cavity indicating sound.

3. The sensor of claim 1, wherein the movable component is an elastically deformable cantilevered beam that changes capacitance with deformation.

4. The sensor of claim 2, wherein the movable component is a movable plate held over the cavity.

5. The sensor of claim 1, wherein the insulating layer has a top surface plane and the first electrode, second electrode, and movable component are in a same plane as the top surface plane of the insulating layer.

6. The sensor of claim 2, wherein the cavity is further formed within the substrate.

7. The sensor of claim 6, wherein the cavity extends through the substrate.

8. The sensor of claim 1, wherein:
the substrate is comprised of bulk silicon; and
the insulating layer is SiO₂.

9. The sensor of claim 1, further comprising a sensing electrode adjacent to the movable component.

10. An actuator, comprising:
a grounded substrate;
an insulating layer on the substrate;
a first repulsive electrode formed on the insulating layer;
a second repulsive electrode formed on the insulating layer;
a first fixed electrode adjacent the first repulsive electrode;
a second fixed electrode adjacent the second repulsive electrode; and
a movable component held between the first fixed electrode and second fixed electrode, the movable component configured to change a capacitance based upon a predetermined condition.

11. The actuator of claim 10, further including a cavity formed in the insulating layer and substrate, the cavity formed between the first repulsive electrode and second repulsive electrode.

12. The actuator of claim 10, wherein the movable component is an elastically deformable beam that changes capacitance with deformation.

13. The actuator of claim 10, wherein the insulating layer has a top surface plane and the first repulsive electrode, second repulsive electrode, first fixed electrode, second fixed electrode, and movable component are in a same plane as the top surface plane of the insulating layer.

14. The actuator of claim 11, wherein the cavity extends through the substrate.

15. The actuator of claim 10, wherein:
the substrate is comprised of bulk silicon; and
the insulating layer is SiO₂.

16. A method of fabricating a sensor, comprising:
placing an insulating layer on a substrate;
creating a first set of features on the insulating layer, the first set of features including:
a first electrode;
a second electrode; and
a movable component; and
forming a fluid flow passage in the insulating layer around, at least, the movable component, with the fluid flow passage configured to allow a fluid flow therethrough such that the movable component changes a capacitance based upon a detected fluid flow.

17. The method of claim 16, further comprising forming a sensing electrode on the insulating layer adjacent to the movable component.

18. The method of claim 16, wherein:
forming a fluid flow passage further includes forming a cavity;
creating a first electrode and second electrode further includes forming a first repulsive electrode and a second repulsive electrode; and
further comprising forming a first fixed electrode and second fixed electrode adjacent the movable component,
wherein the cavity is further formed around the movable component, the first fixed electrode, and second fixed electrode.

19. The method of claim 16, wherein forming the movable component is forming an elastically deformable beam that changes capacitance with deformation.

20. The method of claim 16, wherein forming the movable component includes forming a rotatable structure configured to rotate about a hinge and cause a change in capacitance.
